(19) United States
(12) Patent Application Publication
(10) Pub. No.: US 2016/0114271 A1
(43) Pub. Date: Apr. 28, 2016

(54) CUSTOMIZABLE WATER FILTRATION SYSTEM

(71) Applicant: Russell K. Michaud, Justin, TX (US)

(72) Inventor: Russell K. Michaud, Justin, TX (US)

(21) Appl. No.: 14/923,088

(22) Filed: Oct. 26, 2015

Related U.S. Application Data
(60) Provisional application No. 62/068,708, filed on Oct. 26, 2014.

(51) Int. Cl. B01D 36/02; B01D 29/96; C02F 1/00

(52) U.S. Cl. CPC B01D 36/02; C02F 1/003; B01D 29/96

(57) ABSTRACT

A water filtration system that is configurable by a user is provided. More specifically, the present disclosure relates to a water filtration system comprising a chemical filter with a vessel that has an internal chamber. A user may access the chamber to add or remove water filtration media from the chamber. The water filtration system may also include a mechanical filter. The user can change the arrangement of the filtration system and select one of the chemical and mechanical filters to first treat the untreated water.

### CROSS-REFERENCE TO RELATED APPLICATIONS

This application claims priority under 35 U.S.C. §119(e) to U.S. Provisional Patent Application Ser. No. 62/068,708 filed Oct. 26, 2014, which is incorporated herein in its entirety by reference.

### FIELD

The present disclosure relates generally to a water filtration system that may be customized by a user. More specifically, the present disclosure relates to a novel gravity fed water filtration system for removing contaminates from untreated water. The water filtration system comprises a chemical filter and, optionally, a mechanical filter. The chemical filter includes a vessel with an inlet, an outlet, and an internal chamber adapted to retain a water treatment media selectable by the user. The vessel may be disassembled in order to access the chamber. In this manner, a user may replace the treatment media or adjust the type of treatment media to remove particular chemicals or impurities identified in the untreated water. The chemical filter is adapted to be positioned within a container of untreated water. The untreated water flows through the inlet, into the chamber, and into contact with the water treatment media. The chemically treated water then flows out of the chamber through the outlet and out of the container. The chemically treated water may then optionally flow through the mechanical filter.

### BACKGROUND

Many people do not have access to safe drinking water. As a result, a variety of devices and procedures have been developed for treating or filtering water. Some water filters use a mechanical filter to screen out and remove particulates and biological substances (including bacteria, viruses, protozoa, and helminths) that may be harmful if consumed. Water treatment systems often use chemicals in a liquid or solid state to remove chemicals from the water or kill biological contaminants.

Some known water filters combine a mechanical filter with a chemical filter. One example of this type of filter is referred to as a candle filter. An example of a prior art candle filter 2 that combines a mechanical filter 6 with a chemical filter 10 is illustrated in FIG. 1. The candle filter 2 is installed tank 12 of a water system 4. The tank 12 holds untreated water 14.

The mechanical filter 6 generally comprises at least two portions 6A, 6B that are sealed together to form a chamber 8. Apertures or pores of a predetermined size are formed through at least the first portion 6A of the mechanical filter. The pores prevent contaminates in the untreated water 14 larger than the pores from entering the sealed chamber. A chemical filter media 10 is stored within the sealed chamber 8. After passing through the mechanical filter 6A and the filter media 10, treated water 16 exits out of an aperture 18 of the candle filter 2. These candle filters 2 have many deficiencies.

Generally, mechanical filters with a larger average pore size have a higher flow rate than mechanical filters with a smaller average pore size when other factors are kept constant. However, mechanical filters 6 with a larger average pore size may not be effective at removing certain contaminates from untreated water. Some candle filters 2 have an average pore size that is too large to remove or screen certain contaminates present in the untreated water, such as coliphages. Other candle filters have an average pore size that is smaller than necessary to remove contaminates present in the untreated water. As a result, the flow rate of the mechanical filter is unnecessarily reduced, decreasing the efficiency and utility of the candle filter 2. In some cases, the cost of manufacturing a mechanical filter is inversely related to the average pore size. Accordingly, it is beneficial to select a pore size for mechanical filters that is sufficient to screen out known contaminates. Pore sizes smaller than necessary may increase the cost of the filter and decrease the flow rate of water through the filter. However, as the pore size of candle filters 2 is predetermined by the manufacturer, the pore size may not be adjusted by the user to account for, and adequately screen, contaminates in the user's untreated water. Further, many candle filters 2 use a ceramic mechanical filter 6. It can be difficult to manufacture a ceramic mechanical filter with a substantially uniform pore size, or to ensure the pores are smaller than a predetermined size. Accordingly, some ceramic filters 6 used in candle filters have pores that are inappropriately large.

Many problems with these candle filters 2 result from the seal between the first and second portions 6A, 6B of the mechanical filter. As will be appreciated, the seal must not have any gaps or voids larger than the size of the pores of the mechanical filter. Gaps 9 larger than the pore size of the mechanical filter allow untreated water 14 to bypass 13 the mechanical filter 6.

Some mechanical filters 6 include mating surfaces 7A, 7B on each portion 6A, 6B of the mechanical filter. The mating surfaces 7 are adapted to interconnect the portions of the mechanical filter together. However, it is difficult, and expensive, to form the mating surfaces to tolerances sufficient to prevent gaps 9 larger than the pore size of the mechanical filter.

Because of the difficulty and expense of precisely forming the mating surfaces 7 to high tolerances, a sealant 11 is frequently applied to the mating surfaces 7 between filter portions 6A, 6B. The sealant forms, or supplements, the seal between the mechanical filter portions 6A, 6B. However, in practice it is difficult to apply the sealant evenly to prevent gaps 9. Alternatively, a gasket 11 may be placed between the mating surfaces to form the seal. As will be appreciated, if the gasket is too large, or if seal formed by the gasket is too tight, the gasket will apply a force to the filter portions 6A, 6B. The force applied by the gasket can cause cracks or fractures to form in the filter portions. Further, the sealant or the gasket may fail. Thus, even with a sealant or a gasket, gaps 9 may be present between the filter portions 6A, 6B.

The seal between filter portions 6A, 6B also prevents access to the chamber 8 and the filter media 10 therein. Thus, it is difficult to determine when the useful life of the media has been exceeded. Similarly, when the media has exceeded its useful life, because the chamber is sealed, the media 10 cannot be replaced by a user. As a consequence, the candle filter 2, including the mechanical filter portion 6, which is generally more expensive than the media 10, must frequently be replaced after a predetermined period of use to ensure the chemical filter portion is treating the water sufficiently.

Another problem with the sealed chamber 8 is that it is difficult, if not impossible, for a user to customize the filter media stored in the chamber to treat a particular contaminate present in the untreated water 14. As will be appreciated, the chemical and biological contaminates in untreated water vary widely in both type and concentration. In practice, the manufactures of candle filters 2 select a mix of filter media 10 to place in the sealed chamber 8 that is adapted to treat frequently experienced contaminates. The mix (or concentration) of the filter media may not be appropriate, or necessary, for some users. For example, some filter media may not remove a particular contaminate found in the user's untreated water 14. Other filter media may remove beneficial chemicals, such as fluoride, from the user's water. Still other mixes of filter media may add chemicals, such as chlorine, to the user's treated water 16 or impart a bad taste, color, or smell to the treated water.

In some cases, the manufacturer will provide a candle filter 2 with a customized filter media 10 in the chamber 8 upon request from of a customer. The customize media may be formulated to treat chemicals or contaminates in the untreated water 14 of the particular customer; however, this generally increases the cost or time required to obtain the candle filter 2.

The sealed chamber 8 of the mechanical filter 6 also increases shipping costs for manufacturers and users of these candle filters. Once sealed, the first and second portions 6A, 6B of mechanical filter may not be disassembled for shipping. Thus, sealed mechanical filters 6 take up more volume than a mechanical filter of a similar size that can be disassembled. This is because the components of the disassembled mechanical filter may be stacked together. Further, filter media is generally readily available to users. Because candle filters 2 are shipped to the consumer with the filter media stored in the sealed chamber 8, the weight of the filter media increases the shipping costs. Moreover, some shippers or common carriers may want to inspect the mechanical filter due to security concerns. However, as the chamber of the mechanical filter is sealed, these shippers may not accept the candle filters 2 or allow a user to carry the filter. For example, a user may not be able to carry or check a sealed candle filter 2 on an aircraft, limiting the use of these filters by humanitarian and aide organizations.

In addition, the mechanical filter 6 of candle filters 2 is frequently made of a material that is relatively fragile. As mentioned, many mechanical filters 6 are made of a ceramic material. As a consequence, the mechanical filter may be damaged in many ways. When damaged, untreated water may by-pass 13 the mechanical filter through the damaged area, potentially exposing a user of the damaged filter to harmful biological substances. To exasperate this problem, damage to some mechanical filters can be difficult to detect. A crack 20 in a mechanical filter may not be visible to the human eye, but the crack can be large enough to enable harmful pathogens to by-pass 13 the filter. Thus, even a small crack necessitates replacement of the entire candle filter 2.

Some mechanical filters are also damaged by impact during shipment or during installation in the water system 4. Mechanical filters may also be damaged after installation in the water system in a variety of ways. Foreign objects, such as rocks, may impact the mechanical filter 6 causing damage, including cracks 20.

The ambient environment where the filter is used can also damage the mechanical filter. Candle filters 2 may be installed in a water system 4 that is exposed to freezing temperatures. As will be appreciated, cold weather may freeze water around the exterior of the mechanical filter, applying a force to the filter that can cause fractures. Similarly, water in the chamber 8, or trapped in the pores of the mechanical filter, may freeze. The expansion caused when the water freezes also can fracture the mechanical filter. Unfortunately, for users in remote areas that experience long winters, it is impractical to stop the use of a water system when the temperature is below freezing when there is no other source of safe drinking water.

The pores of the mechanical filter 6 also frequently become obstructed by particulates and by the growth of algae or mold on the filter 6. Dirty filters decrease the flow rate of water through the candle filter 2. For example, in one study, flow rates of a variety of ceramic filters dropped significantly after only 20 hours of use, with the flow rate of the majority of filters tested decreasing by more than 50% compared to flow rates after 3 hours of use. See Amber Franz, A Performance Study of Ceramic Candle Filters in Kenya Including Tests for Coliphage Removal (June 2005) (unpublished Master's thesis, University of North Carolina at Chapel Hill) (available at: http://www.sswm.info/sites/default/files/reference_attachments/FRANZ 2005 A Performance Study of Ceramic Candle Filters in Kenya Including Tests for Coliphage Removal.pdf) which is incorporated herein by reference in its entirety.

To increase the flow rate, a dirty mechanical filter 6 may require cleaning. Unfortunately, there are many ways the mechanical filter may be damaged during the cleaning process. To access the mechanical filter, the water system must frequently be at least partially disassembled. The mechanical filter 6 may be damaged by impact as it is removed from the water system 2 or during the subsequent cleaning. Further, the cleaning process typically includes scrubbing the exterior surface of the mechanical filter 6 with an abrasive material or tool. This scrubbing may damage the exterior surface or decrease the useful life of the mechanical filter. Sometimes it is necessary to remove a portion of the exterior surface of the mechanical filter to expose clean pores and restore the flow rate of the mechanical filter. As a consequence, after the mechanical filter has been cleaned in this manner a number of times it must be replaced. Further, the mechanical filter may become even more prone to damage as successive layers of material are removed during the cleaning. Similarly, the sealant or gasket 11 between the mating surfaces 7 of the chamber may be damaged during the cleaning process. The damage may compromise the seal and allow untreated water enter the chamber 8 by bypassing the mechanical filter 6.

Further, the mechanical filter of the candle filter treats the unfiltered water 14 before the water is treated by the chemical filter. In some environments, it is beneficial to position the chemical filter before the mechanical filter. However, because of the design of the candle filter 2, it is not possible for the user to alter the filter train to place the chemical filter 10 before the mechanical filter 6.

Finally, some sources of untreated water contain contaminates that may be removed, or treated, by use of only one of a mechanical filter or a chemical filter. Said another water, some water sources do not require both mechanical and chemical filtration. Accordingly, it may be beneficial, and less expensive, for a user to install only one of a mechanical filter and a chemical filter. Unfortunately, the chemical filter and the mechanical filter of known candle filters 2 may not be used independently.

These prior art candle filters fail to teach various novel aspects of the present disclosure. Furthermore, many previous attempts to improve candle filters have increased the cost of the filter. Accordingly, there is an unmet need for the water treatment system of the present disclosure.

### SUMMARY

The present disclosure can solve the aforementioned problems. It is one aspect of the present disclosure to provide a water filtration system including a chemical filter and, optionally, a separate mechanical filter. Each of the chemical filter and the mechanical filter may be used independently. Further, the arrangement of the filter train formed by the combination of the chemical filter and the mechanical filter may be altered by the user. Thus, the user may change the order of the chemical and mechanical filters. Optionally, one of the chemical and mechanical filters may be removed. The user may also add supplemental chemical or mechanical filters to the filter train.

It is another aspect of the present disclosure to provide a water filtration system in which the chemical filter treats unfiltered water before the water is treated by the mechanical filter. This arrangement may beneficially enable the mechanical filter to screen bacteria that grow on the chemical media from the treated water. Thus, the mechanical filter prevents bacteria from passing through the water filter system and contaminating the treated water. Further, filtration media of the chemical filter can function as a pre-screen to trap some contaminates before the contaminates reach the mechanical filter. By pre-screening the contaminated water, the media of the chemical filter may reduce the accumulation of contaminates on the mechanical filter, prolonging optimal flow rates through the mechanical filter and reducing the frequency of periodic cleaning of the mechanical filter. It will be appreciated that a mechanical filter may be positioned before the chemical filter. Accordingly, in one embodiment, a mechanical filter treats the unfiltered water before the chemical filter. Optionally, the water filtration system of the present disclosure may include a filter train comprising a first mechanical filter, a chemical filter positioned downstream from the first mechanical filter, and a second mechanical filter positioned downstream from the chemical filter. The first and second mechanical filters may differ in one or more of pore size, flow rate, or filter material. For example, one of the first and second filters may comprise a hollow tube membrane. The other of the first and second filters may comprise a different type of mechanical filter. In one embodiment, one of the first and second mechanical filters may include a ceramic filter. The ceramic filter may be of any size or shape. For example, in one embodiment, the ceramic filter is generally planar. In another embodiment, the ceramic filter is cup or cone shaped.

Optionally, multiple mechanical filters and/or chemical filters may be used in parallel or series in the filter train of the water filtration system of the present disclosure. For example, in one embodiment, the filter train comprises multiple mechanical filters of different types. One mechanical filter may have a larger average pore size then an other mechanical filter. Moreover, one mechanical filter may be formed of a ceramic material and the other mechanical filter may include a membrane material. In one embodiment, the filter system includes at least one mechanical filter with a membrane having pores smaller than about 0.1 micron, much smaller than the pores of ceramic filters. As a consequence, the user can choose a mechanical filter with the largest suitable pore size to adequately filter the water without needlessly reducing the flow rate through the filter system.

Another aspect of the present disclosure is a vessel for a chemical filter with an internal chamber that is accessible by a user. The accessible chamber enables the user to select chemical filtration media to treat water for a particular type of contaminate. Thus, the user may customize the treatment provided by the filter system at low cost. Similarly, the user may re-purpose the chemical filter: (1) if the contaminates in the water change; (2) if the chemical filter is moved to a different location with a different water source; (3) if treatment of the water with chemical filtration media is not required or desired; or (4) to adjust the properties of the treated water produced by the filter system. For example, if the user is not satisfied with some aspect of the treated water (such as the presence of an impurity or the clarity, smell, or taste of the treated water), the user can adjust the filtration media without the necessity of obtaining a new chamber for the media. The user may also ship the chemical filter with the vessel chamber empty to save weight, avoiding the cost of shipping the filtration media. Shipping the vessel chamber empty may also eliminate security concerns, especially if the user would like to carry the chemical filter in a carry-on bag on a commercial aircraft.

In one embodiment, the vessel of the chemical filter generally comprises a first portion interconnected to a second portion. Accordingly, the vessels may be stored and shipped in a disassembled state. In the disassembled state, multiple first portions of vessels may be adapted to at least partially stack together. The second portions may also be adapted to at least partially stack together. By stacking similar portions of multiple vessels together, less volume is required to store or ship a given number of vessels compared to a like number of filters of a similar size that cannot be disassembled.

The accessible vessel chamber permits the user to replace the chemical filtration media periodically without the necessity of replacing the vessel. The chemical filtration media can be in the form of beads, powders, granules, formed between porous membranes or other forms known in the art. Examples of such filter media suitable for use with the water filtration system of the present disclosure are described in U.S. Pat. Nos. 8,252,185; 7,413,663; 7,276,161; 7,153,420; 6,752,768; and 5,635,063, which are each incorporated herein by reference in their entirety. The filtration media can be separated into individual layers within the vessel chamber. Alternatively, the filtration media may be mixed together as a whole or with different combinations of filter media being included as different layers. In addition, the filtration media may be positioned within the vessel chamber in more than one layer comprising a particular filter media or filter media mixture.

In one embodiment, the chemical filtration media comprises one or more of granular activated carbon (GAC), ferrous oxide, electro-chemical oxidation (or “redox”) treatment modules, resins, activated alumina or aluminum in any form (such as nanoalumina fibers), copper granules, zinc granules, silver particles, porous glass beads, iodine resins, schungite, and zeolites. One or more forms of silica, manganese, copper, iron, titanium, zirconium, lanthanum, and cerium may also be included in the filtration media. The filtration media may also include granular ferric oxide, granular ferric hydroxide, lanthanum oxide, kinetic degradation fluxion media alloy, or titanium dioxide among others.

Other chemical purification agents that may be included in the filtration media include pentaiodide resin or any other biocide resin, trichlorocyanuric acid (TCCA), Bromochloro di methyl hydantoin (BCDMH), and/or a combination of TCCA and BCDMH. Halogen releasing compounds may also be included in the filtration media, such as, but not limited to, potassium dischloroisocyanurate, sodium dichloroisocyanurate, chlorinated trisodium phosphate, calcium hypochlorite, lithium hypochlorite, monochloramine, dichloramine, [(monotrichloro)-tetra (monopotassium dichloro)]pentaisocyanurate, 1,3 dichloro-5,5-dimethylidanotone, paratoluene sulfodichloroamide, thrichloromelamine, N-chloramine, N-chlorosuccinimide, N,N′-dichloroazodicarbonamide, N-chloroacetyl-urea, N,N-dichloroazodicarbonamide, N-chloroacetyl-urea, N,N, dichlorbiurite, and chlorinated dicyandiamide. In one embodiment, tablets or granules of TCCA, BCDMH and a combination of TCCA and BCDMH are included in the filtration media.

It is yet another aspect of the present disclosure to provide a water filtration system that is more durable than known candle filters. The water filtration system comprises a vessel for a chemical filter that is made of a durable material. In one embodiment, the vessel is made of one or more of plastic, metal, or a combination thereof. In another embodiment, the material of the vessel is sufficiently durable to prevent the formation of cracks when dropped or subjected to an impact from a hammer or other hard tool. In still another embodiment, the vessel material can absorb a force caused by water expanding as the water freezes without damage to the vessel. The filter vessel may also be made with thinner sidewalls than typical ceramic filters. Accordingly, the filter vessel of the present disclosure generally includes a chamber with an internal volume that is greater compared to an internal volume of a mechanical filter of a candle filter of a similar size and shape. Thus, the vessel chamber may hold more filtration media than the candle filter of similar size and shape. In one embodiment, the mechanical filter is made of a membrane or material adapted to withstand damage caused by freezing water.

Another aspect of the present disclosure is a flange within the chamber of the vessel. The flange projects axially around a radial perimeter of an outlet of the vessel for treated water. The flange prevents untreated water from by-passing the chemical filtration media held in the internal chamber.

In one embodiment of the present disclosure, a novel water filtration system is provided. The water filtration system is configurable by a user and generally comprises, but is not limited to: (1) a chemical and/or biological filter including a vessel with an inlet and an outlet, the vessel including a chamber accessible by the user, the chamber configured to retain a predetermined quantity of chemical filtration media selected by the user; and (2) a mechanical filter with pores of a size selected by the user. The chemical filter and the mechanical filter comprise a filter train that is configurable by the user. In one embodiment, the filter train comprises at least two mechanical filters. In another embodiment, the chemical filter is positioned in the filter train upstream of at least one mechanical filter. In still another embodiment, at least one mechanical filter is positioned in the filter train upstream of the chemical filter.

In one embodiment, the filter train includes a second mechanical filter. Optionally, the second mechanical filter is arranged in series with the mechanical filter and the second mechanical filter is positioned upstream of the chemical filter and the mechanical filter. In one embodiment, the second mechanical filter comprises a fabric material, such as felt. In another embodiment, the second mechanical filter comprises one or more of a different pore size and a different filter material than the mechanical filter. Additionally or alternatively, the second mechanical filter may be arranged in parallel with the mechanical filter. The parallel second mechanical filter may be of the same type and pore size as the mechanical filter. In one embodiment, the second mechanical filter comprises a plurality of mechanical filters.

Optionally, a siphon may be interconnected to an outlet of one of the chemical filter and the mechanical filter.

The vessel of the water filtration system may comprise: (1) a top portion including a plurality of apertures forming the vessel inlet; (2) a bottom portion releasably interconnected to the top portion to form the vessel chamber, the bottom portion including the vessel outlet; and (3) a downspout adapted to be interconnected to the vessel outlet of the bottom portion, the downspout adapted to receive a mechanical filter. In one embodiment, the bottom portion of the chemical filter further comprises a flange projecting axially into the chamber, the flange positioned proximate to a radial edge of the outlet. In another embodiment, the top portion has a shape adapted to enable multiple top portions to be stacked together. In still another embodiment, the bottom portion has a shape adapted to enable multiple bottom portions to be stacked together.

In one embodiment, the top portion is threadably interconnected to the bottom portion. In another embodiment, the top portion includes a recess and the bottom portion includes a projection that at least partially fits into the recess to interconnect the top and bottom portions. In still another embodiment, a mechanical fixture interconnects the top and bottom portions.

Still another aspect of the present disclosure is a novel filter for a water filtration system. The filter includes, but is not limited to: a vessel including (1) a top portion with a plurality of apertures adapted to facilitate a flow of untreated water into the vessel; (2) a bottom portion selectively and removably interconnected to the top portion to form a chamber, the bottom portion including an outlet for treated water; (3) a chemical or biological filtration media removably positioned in the chamber to remove and/or neutralize a selected contaminant; and (4) a downspout interconnectable to the outlet, the downspout adapted to direct the treated water to a storage container. In one embodiment, the downspout is adapted to receive a mechanical filter. In another embodiment, the vessel chamber is accessible by the user and the chamber is configured to retain a predetermined quantity of chemical filtration media selected by the user.

Optionally, the filter may further comprise: (1) a first structure associated with the top portion; and (2) a second structure associated with the bottom portion. The second structure is adapted to be received at least partially within the first structure to interconnect the bottom portion to the top portion.

In one embodiment, the first structure comprises a cavity and the second structure comprises a projection adapted to at least partially fit within the cavity. In another embodiment, the first structure comprises a helical track along an interior surface of the top portion. The second structure comprises at least one tab on an exterior surface of the bottom portion. The at least one tab may be received within the helical track to threadably interconnect the bottom portion to the top portion.

In still another embodiment, the second structure further comprises an aperture adapted to receive a fixture. The fixture is retained at least partially by the first structure to interconnect the bottom portion to the top portion.

Still another aspect of the present disclosure comprises a method of selectively targeting contaminants in an aqueous solution. The method generally comprises, but is not limited to: (1) receiving an aqueous solution comprising a contaminant; (2) passing the aqueous solution through a perforated first structure, the perforated first structure controlling a rate of flow the aqueous solution; (3) thereafter passing the aqueous solution through a filtration media in a chamber to remove or otherwise neutralize the contaminant and form a treated solution; (4) and passing the treated solution through a downspout in a second structure, wherein the first and second structures removably engage one another to enable a user to place selectively different filtration media in the chamber to target one or more other selected contaminants in a different received aqueous solution.

Optionally, the method may include filtering the aqueous solution with the contaminant before passing the aqueous solution through the perforated first structure. In one embodiment, filtering the aqueous solution may comprise passing the aqueous solution through a pre-filter. The pre-filter may comprise a physical barrier of any type selected to remove at least one contaminant from the aqueous solution. The physical barrier may include a porous membrane. Optionally, the physical barrier may comprise a ceramic material. In one embodiment, the physical barrier of the pre-filter comprises a fabric, such as, but not limited to, felt. In another embodiment, the pre-filter comprises a plurality of pre-filters of the same type in parallel.

Additionally or alternatively, the method may also include interconnecting a mechanical filter to the downspout in the second structure. The mechanical filter may include a physical barrier of a different type or different material than the physical barrier of the optional pre-filter. In one embodiment, the mechanical filter has a pore size that is smaller than the pore size of the pre-filter. In another embodiment, the mechanical filter comprises a plurality of mechanical filters arranged in parallel. In still another embodiment, the mechanical filter comprises a hollow tube membrane. Optionally, the mechanical filter is positioned a pre-determined distance from the downspout. In one embodiment, the mechanical filter is interconnected to an outlet of a hose and an inlet of the hose is interconnected to the downspout. Optionally, the hose may be insulated to protect the hose, the aqueous solution, and/or the mechanical filter from freezing temperatures.

Additionally or alternatively, the method may further comprise testing the received aqueous solution to determine the type and quantity of contaminants present. In response to determining the type and quantity of contaminants present, the method may optionally comprise adjusting at least one of the type and quantity of filtration media that the aqueous solution passes through. The method may also include adjusting the rate of flow of the aqueous solution through the filtration media.

It will be appreciated that the method may also include testing the treated solution to determine the type and quantity of contaminants present, if any, in the treated solution. The method may comprise: testing the solutions initially received; testing the treated solution; testing the treated solution after a period of time of use of the filtration media; testing the treated solution periodically; and/or testing the treated solution after changing the configuration of the system. If the treated solution includes a contaminant, the method may further comprise one or more of: (1) passing the aqueous solution through a pre-filter; (2) adjusting the type or quantity of filtration media and/or the rate of flow of the aqueous solution through the filtration media; (3) and interconnecting a mechanical filter to the downspout in the second structure to remove the contaminant present. After performing one or more of optional actions 1-3 above, the treated solutions may optionally be tested again. If the treated water includes a contaminant, one or more of options 1-3 above may be performed again. For example, the type of style of pre-filter may be adjusted. The filtration media may be changed. The rate of flow of the aqueous solution may be adjusted. Additionally, the type or style of mechanical filter interconnected to the downspout may be adjusted.

In one embodiment, the rate of flow of the aqueous solution may be adjusted by a user by changing at least one of the size, shape, and number of perforations in the first structure. Changing the number of perforations may comprise covering or blocking one or more of the perforations. Optionally, the rate of flow may be adjusted by replacing the first structure with a different first structure. In still another embodiment, the rate of flow through the perforated first structure may be adjusted by altering or removing a mechanical screen retained in a portion of the downspout. In yet another embodiment, the rate of flow may be altered by interconnecting a mechanical filter to the downspout, wherein pores in the mechanical filter restrict the flow of the aqueous solution through the downspout.

Additionally, the method may comprise monitoring the volume of aqueous solution passing through the filtration media. After a predetermined volume of water has passed through the filtration media, the method may include removing the filtration media and adding the different filtration media to the chamber.

By way of providing additional background, context, and to further satisfy the written description requirements of 35 U.S.C. §112, the following patents and patent publications are incorporated by reference in their entireties for the express purpose of explaining and further describing components of water filters of various types and other apparatus commonly associated therewith to provide additional written description support for various aspects of the present disclosure: U.S. Pat. No. 2,879,207, U.S. Pat. No. 3,339,743, U.S. Pat. No. 4,094,779, U.S. Pat. No. 4,800,018, U.S. Pat. No. 5,128,036, U.S. Pat. No. 5,616,243, U.S. Pat. No. 6,129,841, U.S. Pat. No. 6,419,821, U.S. Pat. No. 7,018,528, U.S. Pat. No. 7,156,994, U.S. Pat. No. 7,906,019, U.S. Pat. No. 8,623,206, U.S. Pat. App. Pub. No. 2006/0144781, U.S. Pat. App. Pub. No. 2008/0202992, U.S. Pat. App. Pub. No. 2011/0079551, U.S. Pat. App. Pub. No. 2011/0303589, U.S. Pat. App. Pub. No. 2012/0055862, U.S. Pat. App. Pub. No. 2012/0267314, U.S. Pat. App. Pub. No. 2013/0277298, U.S. Pat. App. Pub. No. 2014/0076792, U.S. Pat. App. Pub. No. 2014/0144829, U.S. Pat. App. Pub. No. 2014/0190883, U.S. Pat. App. Pub. No. 2014/0216993, European Patent No. EP 2,609,037, International Publication No. WO 99/00331, International Publication No. WO 2007000238, International Publication No. WO 2007/144256, International Publication No. WO 2010/034687, International Publication No. WO 2014/071346, International Publication No. WO 2014/144191, International Publication No. WO 2014/145435, International Publication No. WO 2015/054620, and International Publication No. WO 2015/128372.

The above-described embodiments, objectives, and configurations are neither complete nor exhaustive. As will be appreciated, other embodiments of the disclosure are possible using, alone or in combination, one or more of the features set forth above or described in detail below.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Although various dimensions are provided to illustrate exemplary embodiments of water filters and the components thereof, and it is expressly contemplated that dimensions may be modified in the water filters of the present disclosure and still comport with the scope and spirit of the disclosure. Thus, unless otherwise indicated, all numbers expressing quantities, dimensions, conditions, and so forth used in the specification and claims are to be understood as being modified in all instances by the term “about.”

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and Claims themselves.

The Summary is neither intended nor should it be construed as being representative of the full extent and scope of the present disclosure. Moreover, references made herein to “the present disclosure” or aspects thereof should be understood to mean certain embodiments of the present disclosure and should not necessarily be construed as limiting all embodiments to a particular description. The present disclosure is set forth in various levels of detail in the Summary as well as in the attached drawings and the Detailed Description and no limitation as to the scope of the present disclosure is intended by either the inclusion or non-inclusion of elements or components. Additional aspects of the present disclosure will become more readily apparent from the Detailed Description, particularly when taken together with the drawings.

### BRIEF DESCRIPTION OF DRAWINGS

The accompanying drawings, which are incorporated herein and constitute a part of the specification, illustrate embodiments of the disclosure and together with the Summary of the Disclosure given above and the Detailed Description of the drawings given below serve to explain the principles of these embodiments. In certain instances, details that are not necessary for an understanding of the disclosure or that render other details difficult to perceive may have been omitted. It should be understood, of course, that the disclosure is not necessarily limited to the particular embodiments illustrated herein. Additionally, it should be understood that the drawings are not necessarily to scale.

FIG. 1 is a cross sectional front elevation view of a prior art candle water filter installed in a water system;

FIG. 2 is a cross-sectional front elevation view of an embodiment of a water filtration system of the present disclosure;

FIG. 3 is an exploded front elevation view of a filter train of the water filtration system of FIG. 2;

FIG. 4 is a top perspective view of a chemical filter of the water filtration system of FIG. 2;

FIG. 5 is an exploded top perspective view of the chemical filter of FIG. 4;

FIG. 6 is a front elevation view of the chemical filter of FIG. 4;

FIG. 7 is a bottom plan view of the chemical filter of FIG. 4;

FIG. 8 is a top plan view of the chemical filter of FIG. 4;

FIG. 9 is a cross-sectional front elevation view taken along line 9-9 of FIG. 8 illustrating interior details of the chemical filter of FIG. 4, and line 9-9 also defining an exemplary axis about which half sections of the chemical filter are substantially symmetrical;

FIG. 10 is a cross-sectional perspective view taken along line 9-9 of FIG. 8;

FIG. 11 is a cross-sectional perspective view of a downspout of an embodiment of the present disclosure;

FIG. 12 is a top perspective view of base plate of a chemical filter according to another embodiment of the present disclosure and illustrating a plurality of outlets for treated water formed in the base plate;

FIG. 13 is a cross-sectional front elevation view of a water filtration system according to another embodiment of the present disclosure, the water filtration system comprising a plurality of mechanical filters positioned in parallel in a filter train before an optional chemical filter and an optional second mechanical filter; and

FIG. 14 is a flow diagram of a method for selectively targeting contaminants in an aqueous solution.

Similar components and/or features may have the same reference number. Components of the same type may be distinguished by a letter following the reference number. If only the reference number is used, the description is applicable to any one of the similar components having the same reference number.

To assist in the understanding of one embodiment of the present disclosure the following list of components and associated numbering found in the drawings is provided herein:

| Number | Component |
|---|---|
| 2 | Prior art candle filter |
| 4 | Water system |
| 6 | Mechanical filter |
| 7 | Mating surfaces |
| 8 | Chamber |
| 9 | Gap |
| 10 | Chemical filter |
| 11 | Sealant or gasket |
| 12 | Tank |
| 13 | Flow through gap or crack |
| 14 | Untreated water |
| 16 | Treated water |
| 18 | Aperture |
| 20 | Crack |
| 104 | Water filtration system |
| 112 | Container for untreated water |
| 114 | Untreated water |
| 116 | Treated water |
| 122 | Chemical filter |
| 124 | Chamber |
| 126 | Top portion |
| 128 | Apertures |
| 130 | First structure |
| 132 | Ribs |
| 134 | Bottom portion |
| 135 | Circumferential flange |
| 136 | Outlet |
| 137 | Seat |
| 138 | Flange |
| 140 | Grooves in outlet |
| 142 | Second structure |
| 144 | Downspout |
| 146 | Inlet Threads |
| 147 | Gasket |
| 148 | Radial flange |
| 150 | Shoulder |
| 152 | Outlet |
| 154 | Outlet screen |
| 156 | Outlet aperture |
| 158 | Outlet threads |
| 160 | Chemical filtration media |
| 162 | Media container |
| 170 | Mechanical filter |
| 172 | Adapter |
| 178 | Pre-filter |
| 180 | Filter train |
| 182 | Container for treated water |
| 184 | Spigot |
| 186 | Container lid |
| 188 | Siphon |
| 204 | Water filtration system |
| 212 | Container for untreated water |
| 214 | Untreated water |
| 216 | Treated water |
| 217 | Treated water |
| 222 | Chemical Filter |
| 244 | Downspout |
| 270 | Mechanical filter |
| 278 | Pre-filter |
| 282 | Container for treated water |
| 283 | Third container |
| 284 | Spigot |
| 286 | Container lid |
| 288 | Siphon |
| 290 | UV light source |

### DETAILED DESCRIPTION

The present disclosure has significant benefits across a broad spectrum of endeavors. It is the Applicant's intent that this specification and the claims appended hereto be accorded a breadth in keeping with the scope and spirit of the disclosure being disclosed despite what might appear to be limiting language imposed by the requirements of referring to the specific examples disclosed. To acquaint persons skilled in the pertinent arts most closely related to the present disclosure, a preferred embodiment that illustrates the best mode now contemplated for putting the disclosure into practice is described herein by, and with reference to, the annexed drawings that form a part of the specification. The exemplary embodiment is described in detail without attempting to describe all of the various forms and modifications in which the disclosure might be embodied. As such, the embodiments described herein are illustrative, and as will become apparent to those skilled in the arts, may be modified in numerous ways within the scope and spirit of the disclosure.

Although the following text sets forth a detailed description of numerous different embodiments, it should be understood that the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims. To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning.

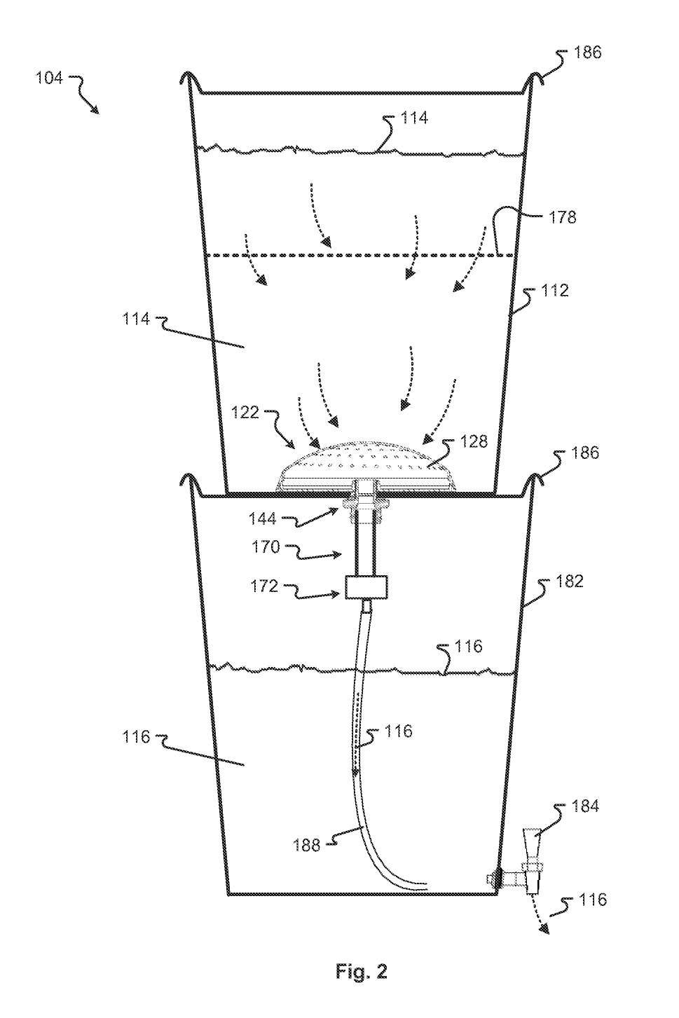

Referring now to FIG. 2, a water filtration system 104 of an embodiment of the present disclosure is illustrated. The system 104 generally comprises a first container 112, a chemical filter 122, a separate mechanical filter 170 that may optionally be interconnected to the system 104, and a second container 182.

The first container 112 holds a quantity of untreated water 114. The untreated water flows into the chemical filter 122 through a plurality of apertures 128 in the chemical filter. In one embodiment, the chemical filter has a height of less than about 2.5 inches and a diameter of less than about 8 inches. In a more preferred embodiment, the chemical filter is approximately 2 inches in height and has a diameter of approximately 7 inches. Other sizes are contemplated without departing from the present disclosure.

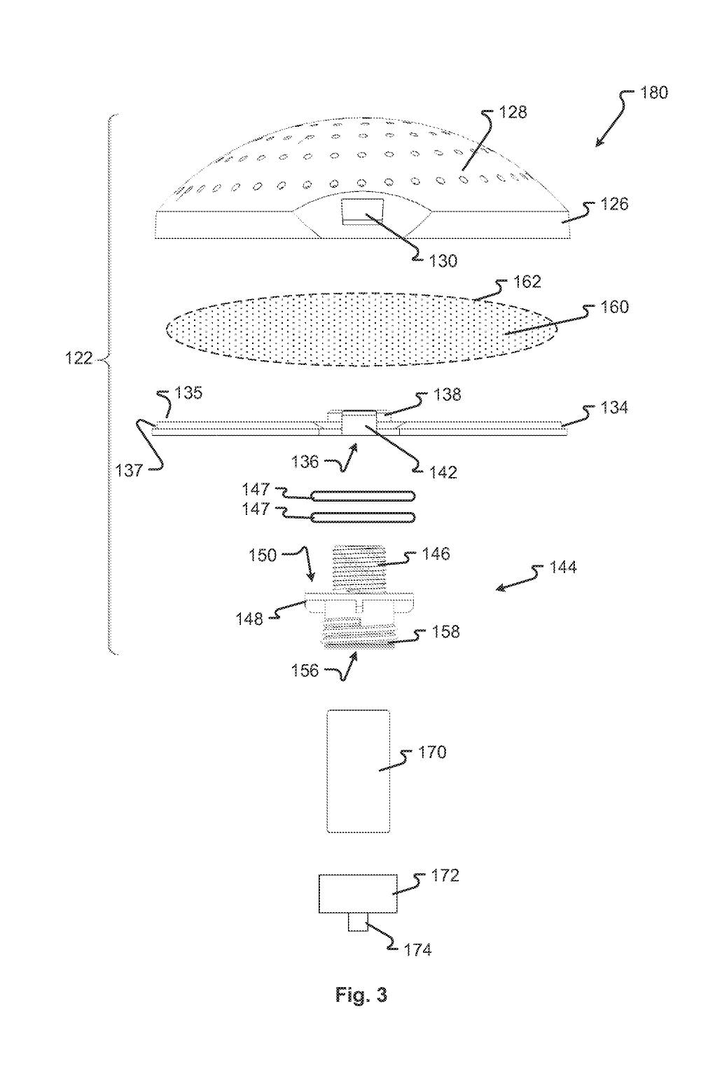

Within the chemical filter 112, the water flows through a chemical filtration media 160 (illustrated in FIG. 3) selected by the user. The chemically treated water flows out of an outlet of the chemical filter. The outlet is interconnected to a downspout 144 that fits through apertures in the first and second containers 112, 182. The water then flows through an inlet of the mechanical filter 170 interconnected to the downspout. The treated water 116 flows out of an outlet of the mechanical filter 170 and is collected in the second container 182.

Additionally or alternatively, the water filtration system 104 may include an optional pre-filter 178 (FIG. 2) to screen contaminates, such as entrained solids (e.g., sediment), microbes, and other entrained undissolved contaminants, out of the water. The pre-filter 178 generally comprises a material with pores larger than the pores of the mechanical filter 170. The pre-filter may comprise a fabric or mesh material that includes one or more natural or synthetic fibers. In one embodiment, the pre-filter comprises one or more of nylon, cotton, wool, wood fiber, paper, and metallic wire. In another embodiment, the pre-filter is made of felt. In still another embodiment, the pre-filter may comprise a membrane with pores of a predetermined size. In one embodiment, the pre-filter comprises a ceramic material. For example, the pre-filter may comprise a ceramic pot positioned within the first container 112. An opening of the ceramic pot may be oriented facing upward away from the chemical filter 122. Water poured into the ceramic pot is strained through the pores of the pot and collects in the first container 112.

The pre-filter 178 may be positioned in a variety of locations. In one embodiment, illustrated in FIG. 2, the pre-filter 178 is positioned within the first container 112. The pre-filter 178 may also be positioned in contact with the chemical filter 122. For example, in one embodiment, the pre-filter comprises a bag or tube made of a fabric. The chemical filter 122 may be positioned within the interior of the bag or tube.

Optionally, the system may include an outlet 184 positioned in the second container 182. The outlet 184 is adapted to selectively extract treated water 116 from the second container. In one embodiment, the outlet is a spigot.

The system 104 may optionally include a siphon 188 interconnected to the outlet of the mechanical filter 170. The siphon may comprise a portion of tubing with a length sufficient to at least reach the bottom of the second container 182. As will be appreciated by one of skill in the art, interconnecting a siphon to the system 104 can increase the flow rate of water through the system 104.

It will be appreciated that the containers 112, 182 may be of any size, shape, or material. Further, although the containers 112, 182 are illustrated positioned proximate to each other in a stacked arrangement, the containers may be separated by any desired distance. For example, in one embodiment of the present disclosure, a proximal end of a pipe or hose is interconnected to the outlet of the mechanical filter 170. The hose may be of any length. A distal end of the hose is interconnected to an inlet of the second container 182. In another embodiment, a hose or pipe is interconnected to the outlet of the downspout 144. The mechanical filter may be placed within a portion of the pipe. Optionally, the mechanical filter may be interconnected to a distal end of the pipe. In this manner, the mechanical filter 170 may be arranged a distance downstream from the chemical filter.

One or more of the containers 112, 182 may also include a lid 186. The lid 186 beneficially prevents infiltration of contaminates into the containers.

It will be appreciated that other methods of treating water may be incorporated in the water filtration system of the present disclosure. For example, in one embodiment of the present disclosure, the filtration system 104 includes a pre-vessel positioned upstream of container 112. A coagulant is added to the untreated water in the pre-vessel to remove contaminates or cause the contaminates to clump together. In another embodiment, ozone may be introduced to the untreated water by the filtration system to disinfect the water. In yet another embodiment, the filtration system 104 includes an ultraviolet light source to kill organisms present in the untreated water.

Referring now to FIG. 3, an exploded view of a filter train 180 of an embodiment of the water filtration system 104 of the present disclosure is illustrated. The filter train 180 includes, but is not limited to, the chemical filter 122 and the filter 170. It will be appreciated by one of skill in the art that the order, and location, of the chemical and mechanical filters of the filter train 180 may be altered. While the filter 122 is discussed with reference to a chemical filter, it is to be understood that it can also or additionally be a biological filter.

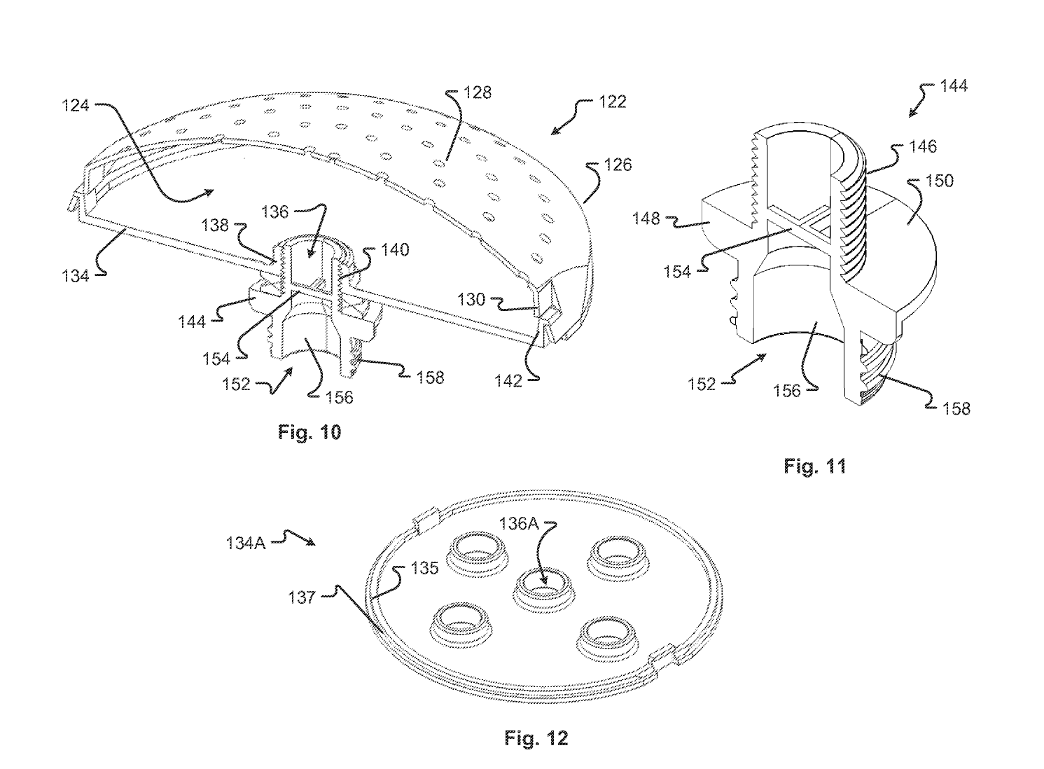

In one embodiment, the chemical filter 122 comprises a top portion 126 selectively removably interconnected to a bottom portion 134. The top and bottom portions 128, 134 form a chamber 124 (illustrated in FIGS. 9-10) adapted to retain a predetermined quantity of a chemical filtration media 160. Any type of filtration media selected by the user may be held in the chemical filter. Examples of suitable filtration media are describe above and may be in the form of beads, powders, granules, formed between porous membranes or other forms known in the art.

The chemical filtration media 160 may be loose within the chamber. Additionally or alternatively, the chemical filtration media 160 can be held within a water permeable container 162. The container 162 includes apertures of a predetermined size. In one embodiment, the container is made of the same material as the pre-filter described above in conjunction with FIG. 2. In another embodiment, the container 162 is made of a felt material. Optionally, two or more containers 162 may be used to retain the filtration media in the chamber 124. In one embodiment, different filtration media is contained in each different container 162.

Optionally, the chemical filter 122 may be used without the chemical filtration media. If the user does not need to chemically treat the water (for example, if the water will not be ingested), or if the untreated water does not contain chemicals or organisms that require removal, the chemical filter can be configured as a pre-screen for a downstream filter 170. Accordingly, the chamber 124 of the chemical filter 122 may be filled with a material, the same as or similar to the material of the pre-screen 178 described above, with a desired pore size.

The removable engagement of the top and bottom portions 126 and 134 can enable a user to configure the filter train as needed to meet the demands of the particular application and/or replace spent filtration media with fresh filtration media, thereby prolonging the life of the filter train. In some applications, the solution to be treated can include dissolved and un-dissolved solids as well as microbes. The filter train would, in that application, have the configuration of FIG. 2, with a chemical filtration media present in the chamber 124. In other applications, the water may have a low un-dissolved solids content but a high dissolved solids content, thereby obviating the need for a pre-filter but requiring the chemical filtration media. Different types of filtration media can be combined in the chamber, such as chemical and biological media and the like.

The top portion includes a plurality of apertures 128. The apertures have a predetermined size and shape adapted to enable a predetermined rate of water to flow into the chemical filter 122. In one embodiment, the apertures are generally circular in shape. Optionally, the apertures may be of a variety of different shapes including one or more of square, circular, rectangular, and triangular. In one embodiment, the apertures have a diameter of between approximately 0.10 inches and approximately 0.15 inches. In a more preferred embodiment, the diameter of the apertures is approximately 0.125 inches. In another embodiment, the apertures are at least about 0.05 inches in diameter. However, other sizes are contemplated. It will be appreciated that the apertures may have a variety of sizes. For example, in one embodiment, at least some of the plurality of apertures have a first diameter and other apertures have different diameters.

The top portion 126 has a generally round cross section. The round shape of the top portion 126 increases the surface area of the top portion and increases the number of apertures that may be formed in the top portion. Other shapes are contemplated for the top portion. In one embodiment, the top portion has a generally cylindrical shape or a generally conical shape. In another embodiment, the top portion has a shape selected to facilitate stacking of multiple top portions 126 together. In this manner, the top portions 126 may be stacked or nested together to reduce the space required to store or ship the top portions.

The top portion 126 is formed of a durable material. In one embodiment, the top portion may be formed of a resilient material that is at least partially flexible or deformable to accommodate differing volumes of chemical filtration media. In one embodiment, the top portion 126 is made of one or more food grade materials such as plastic, rubber, metal, or a combination thereof. In another one embodiment, the top portion is made of high density polyethylene (HDPE). In another embodiment, the material of the top portion comprises one of thermoplastic rubber (TPR) and a thermoplastic elastomer (TPE). Optionally, the top portion may be made of a material that can withstand high temperatures used to clean and sterilize the top portion. A silver coating may also be applied to the top portion to provide further anti-bacterial treatment to the water.

The bottom portion 134 has a diameter that is substantially the same as a diameter of the top portion 126. In one embodiment, the bottom portion has a substantially planar cross section. In another embodiment, the bottom portion has a shape selected to allow multiple bottom portions to be stacked together. Accordingly, similar to the top portions, multiple bottom portions 134 may be stacked or nested together to reduce the space required to store or ship the top portions. In still another embodiment, the bottom portion has a cross-sectional shape substantially the same as the shape of the top portion. The bottom portion may include a circumferential flange 135 proximate to an exterior radial edge. In one embodiment, the flange 135 is set back from the radial edge a distance about equal to a cross-sectional thickness of the top portion 126. In this manner, a seat 137 is formed for the top portion 126 radially outward of the flange 135.

An outlet 136 is formed in the bottom portion. In one embodiment, the outlet has a diameter of between approximately 0.5 inches to approximately 1.0 inch. In a more preferred embodiment, the outlet has a diameter of about 0.75 inches. Optionally, a flange is positioned proximate to a radial edge of the outlet. The flange extends axially within the chamber 124. The flange 138 prevents untreated water from flowing around the filtration media 160 and through the outlet. More specifically, when the filtration media 160 is placed in the chamber 124 of the chemical filter and the top portion is interconnected to the bottom portion, the top portion 126 at least partially compresses the filtration media 160. The compression force applied to the filtration media presses the filtration media against the flange 138, preventing untreated water from flowing around the media without treatment by the media. Optionally, at least some of the filtration media may be placed within the interior of the flange 138 to provide further contact with the water as the water exits the chamber. In one embodiment, the flange 138 has a height of between about 0.25 inches and about 0.75 inches. In a more preferred embodiment, the height of the flange 138 is about 0.50 inches. In still another embodiment, the flange 138 has a height that is at least two times the height of the circumferential flange 135. Grooves 140 (illustrated in FIG. 10) adapted to receive threads of the downspout may optionally be formed on the radially inward side of the flange 138.

The bottom portion 134 may be formed of the same material as the top portion 126. Optionally, each of the top and bottom portions 126, 134 may be made of a different material. For example, in one embodiment, the top and bottom portions are made of materials of different densities or thicknesses. In another embodiment, the top portion is made of a stronger or more rigid material than the bottom portion. The bottom portion may also be generally thinner than the top portion. In this manner, the top portion is protected from damage caused by impacts from objects in the untreated water, including rocks.

A downspout 144 is interconnected to the outlet 136 formed in the bottom portion. A flange 148 may extend radially from a medial portion of the downspout 144. The flange 148 has a radius sufficient to form a shoulder 150. The shoulder 150 is adapted to retain a washer or a gasket 147 on the downspout. The gasket may be formed of any pliable material that is substantially impermeable to water. As the downspout 144 is interconnected to the outlet 136 of the bottom portion, the gasket 147 may be compressed between a bottom surface of the bottom portion and the flange 148 to create, or improve, a seal between the downspout and the bottom portion. In one embodiment, illustrated in FIG. 3, two gaskets 147 are positioned between the bottom portion 134 and the downspout 144.

In one embodiment, the downspout includes threads 146 to engage grooves formed in the outlet. However, the downspout may be interconnected to the outlet of the bottom portion by any suitable means. In another embodiment, the downspout is held in the outlet by a friction fit. In still another embodiment, a mechanical fastener, such as a wing nut, may be secured to threads formed on the downspout to interconnect the downspout to a lid 186 of a container to prevent water from flowing around the downspout through a hole in the lid. One or more pliable, water proof washers may additionally be used to ensure water does not enter the second container 182 through the hole in the container lid 186.

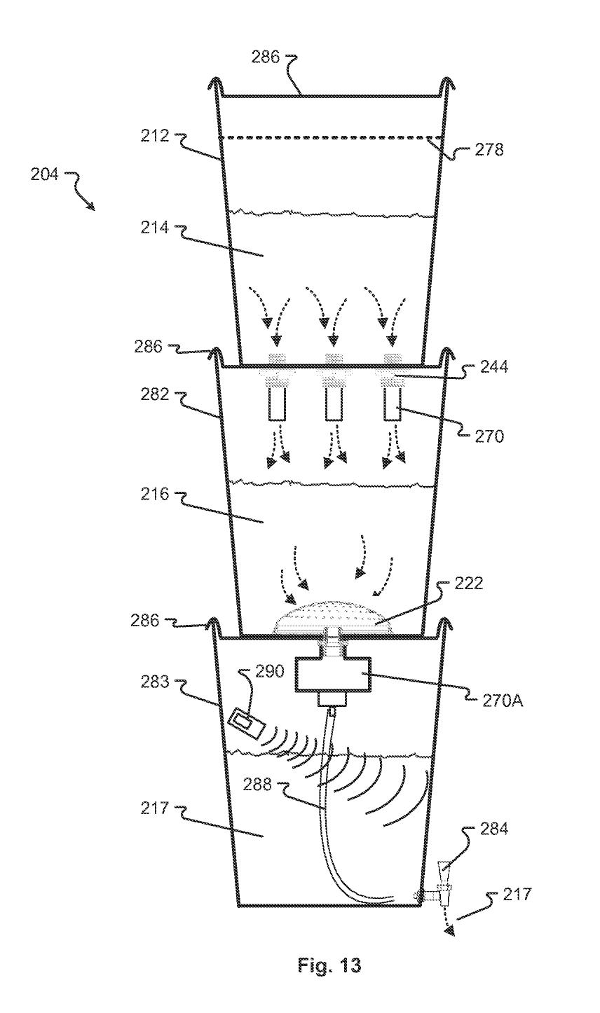

An outlet 152 of the downspout 144 is adapted to receive an optional mechanical, chemical or biological filter 170. In the embodiment illustrated in FIG. 3, the filter 170 is adapted to fit at least partially within an aperture 156 of the outlet 152. However, in another embodiment, illustrated in FIG. 13, a filter 170A may have a threaded inlet adapted to engage threads 158 formed on an exterior of the downspout proximate to the downspout outlet 152. Accordingly, the outlet 152 is adapted to receive mechanical filters of a variety of types and sizes. In one embodiment, the threads 146 proximate to the inlet of the downspout have a diameter that is less than the diameter of the threads 158 proximate to the outlet of the downspout.

Additionally or alternatively, a filter 170 may be positioned a predetermined distance from downspout. The filter 170 may be interconnected to the filtration system 104 with a hose or pipe that is interconnected to the outlet of the downspout. In this manner, the filter may be positioned in an environment protected from freezing temperatures to prevent damage to the filter. For example, it may be impractical to locate the untreated water container 112 of the water filtration system 104 in an area protected from freezing temperatures because of the difficulty of transporting untreated water. However, by connecting a hose to the outlet of the downspout and placing the mechanical filter within, or in-line with, the hose, the filter may be separated from the untreated water container 112 by a significant distance. In one embodiment, the hose with the filter may enter a structure with an interior temperature that does not drop below freezing. In another embodiment, the hose may be insulated to protect the mechanical filter from freezing temperatures. In still another embodiment, the insulation comprises a layer of earth through which the hose passes.

As will be appreciated, the filter may comprise a variety of filtration means. The filtration means comprises any structure that creates a barrier that allows the passage of water through the pores but prevents selected contaminants from passing through the pores, by physically blocking passage in the case of a mechanical filter, collection and/or removal from the water in the case of a chemical filter, or killing or neutralizing the contaminant in the case of microbes or chemical contaminants. For example, a mechanical filter prevents particles above a predetermined pore size from passing through the pores. In one embodiment, the filtration means is a hollow tube membrane. In another embodiment, the filtration means comprises a membrane sheet. In yet another embodiment, the filtration means includes a ceramic material of any size or shape. In one embodiment, the mechanical filter has a pore size of less than about 4 microns. The pore size may also be less than about 2 microns. In another embodiment, the mechanical filter has a pore size of less than about 0.1 micron. In still another embodiment, the pore size of the mechanical filter is less than about 0.02 microns. Suitable mechanical filters are available from Sawyer Products and are advertised at: https://sawyer.com/products/type/water-filtration/. Mechanical filters available from other suppliers may be used with the water filtration system of the present disclosure.

Optionally, an adapter 172 may be interconnected to an outlet of the mechanical filter. The adapter 172 may have a smaller outlet diameter than the filter outlet. In one embodiment, the adapter 172 has a size selected to engage a drinking straw or a siphon. The adapter 172 may also be used to interconnect a piston or syringe to the outlet of the mechanical filter. As will be appreciated by one of skill in the art, the syringe may be used to force clean water through the mechanical filter from the outlet side to the inlet side of the mechanical filter. Said another way, the syringe may be used to back flush the mechanical filter to remove particulates and contaminates that have accumulated within the mechanical filter. As will be appreciated, candle filters 2 described above generally cannot be cleaned by backflushing.

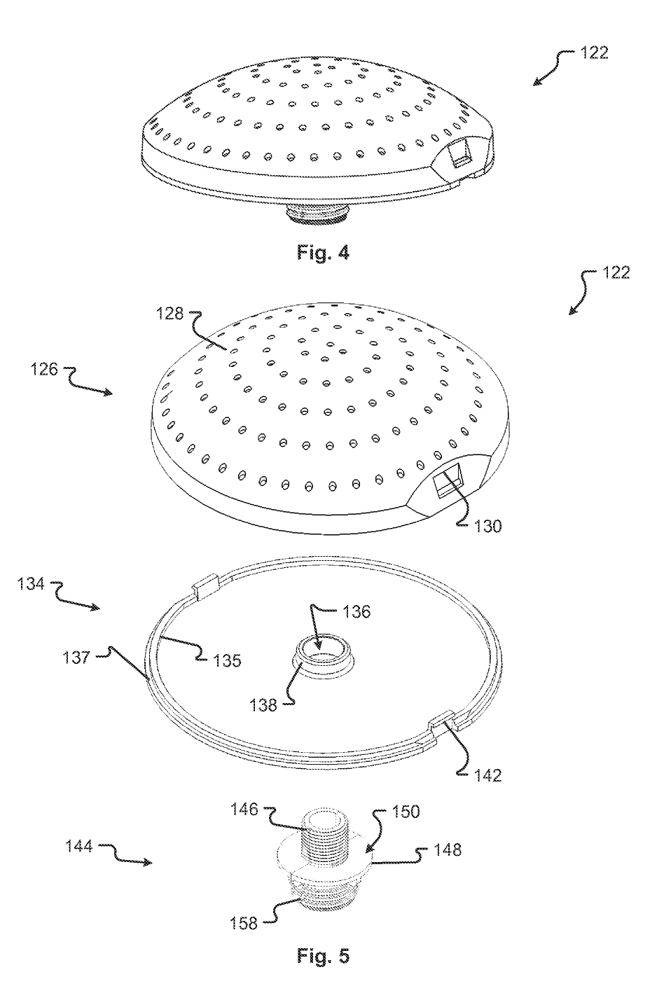

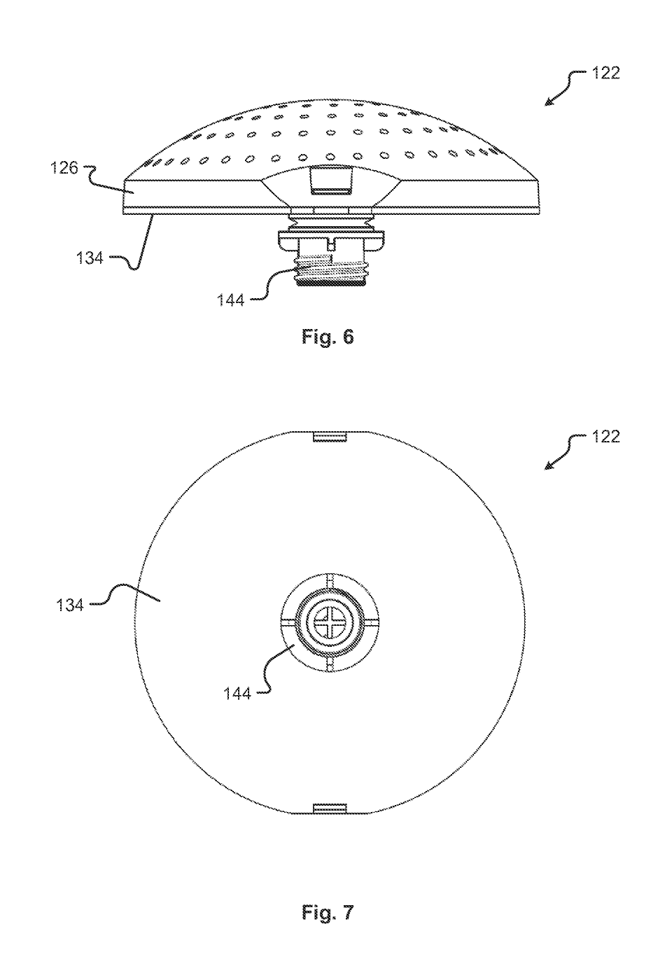

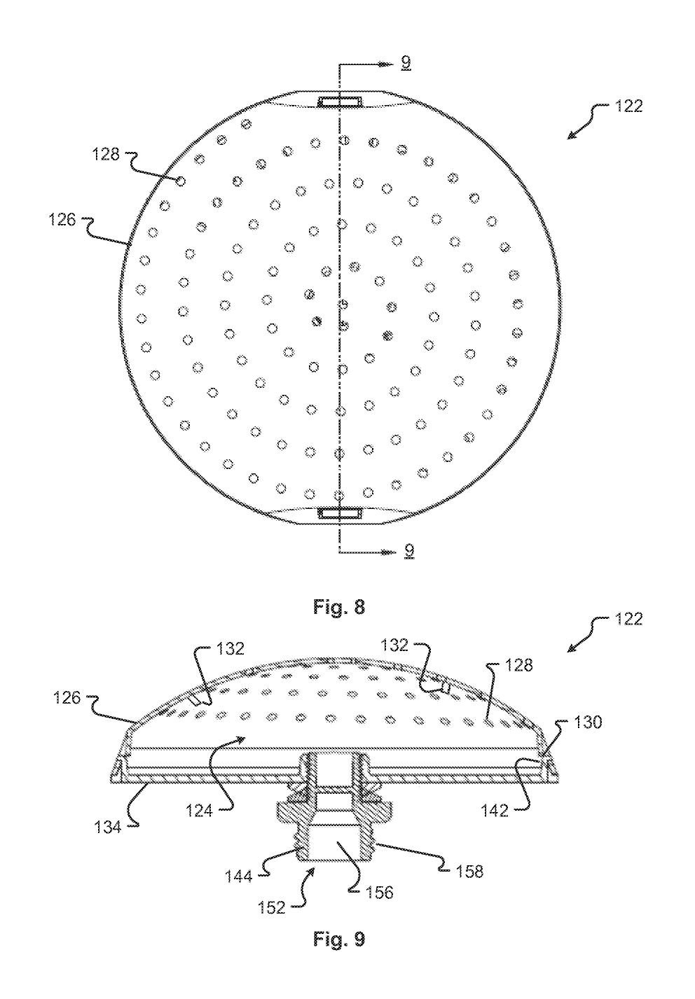

Referring now to FIGS. 4-11, additional views of a chemical filter 122 of the present disclosure are provided. As shown, for example, in FIGS. 4-5, the top portion includes a first structure 130 and the bottom portion includes a second structure 142. The first structure 130 is adapted to at least partially receive the second structure 142 to selectively interconnect the first portion to the second portion. In one embodiment, the first structure 130 comprises a cavity formed on an interior surface of the first portion. In this embodiment, the second structure 142 comprises a projection adapted to at least partially fit within the cavity 130. It will be appreciated that the first and second portions may be interconnected in other suitable ways. For example, in one embodiment, the first structure comprises threads, such as helical threads, formed in an interior surface of the top portion. The second structure comprises at least one tab adapted to be received in, or engage, the threads of the first structure. Accordingly, the first and second portions may be threadably engaged. Optionally, a mechanical fixture, such as a screw, may be used to interconnect the first and second portions. The first and second portions may also be interconnected by a hinge, magnets, a snap, a buckle, and/or a flange that creates a friction fit.

In one embodiment, illustrated in FIG. 9, ribs 132 may be incorporated on the interior surface of the top portion 126. As will be appreciated, the ribs 132 provide additional strength to the top portion 126. The ribs may be of a variety of sizes.

Optionally, as seen in FIGS. 10-11, the downspout 144 may include a screen 154 within a bore of the downspout. The screen may have a variety of shapes. In one embodiment, the screen 154 has an “X” shape. A user may position a pre-filter, the same as or similar to pre-filter 178, on the side of the screen 154 proximate to the bottom portion 134.

Referring now to FIG. 12, another embodiment of a bottom portion 134A is illustrated. The bottom portion 134A comprises five outlets 136. Any number of outlets 136 may be formed in the bottom portions of chemical filters 122 of the present disclosure. It will be appreciated that a mechanical filter 170 may be interconnected to each of the outlets, increasing the flow rate of water through the water filtration system.

Referring now to FIG. 13, another embodiment of a water filtration system 204 of the present disclosure is illustrated. System 204 is similar to system 104 described above and includes a chemical filter 222 that is the same as, or similar to, chemical filter 122. Additionally, system 204 includes a plurality of mechanical filters 270 arranged in parallel. The mechanical filters 270 are generally the same as mechanical filters 170. However, the mechanical filters 270 may have a different pore size than mechanical filter 170. The water 216 treated by the mechanical filters is subsequently treated by chemical filter 222. As described above, the chemical filter may include any chemical filtration media selected by the user. Optionally, the system 204 can be used without chemical filtration media in the chamber of the chemical filter 222.

The water filtration system 204 may also include an optional second mechanical filter 270A. Filter 270A includes an inlet with a diameter larger than the exterior threads of the downspout outlet 136. In one embodiment of the present disclosure, filter 270A has a different pore size, or flow rate, than mechanical filters 270. In another embodiment, filter 270A has a smaller pore size than filters 270. Optionally, filter 270A may include a ceramic barrier.

Additionally or alternatively, the filtration system 204 may further comprise an ultraviolet light 290. In one embodiment, the UV light 290 is located within the third container 283. However, the ultraviolet light may be positioned at any location of the filtration system 204, including one or more of the first and second containers 212, 282. Additionally, the UV light 290 may have any desired frequency of UV light or intensity of UV light.

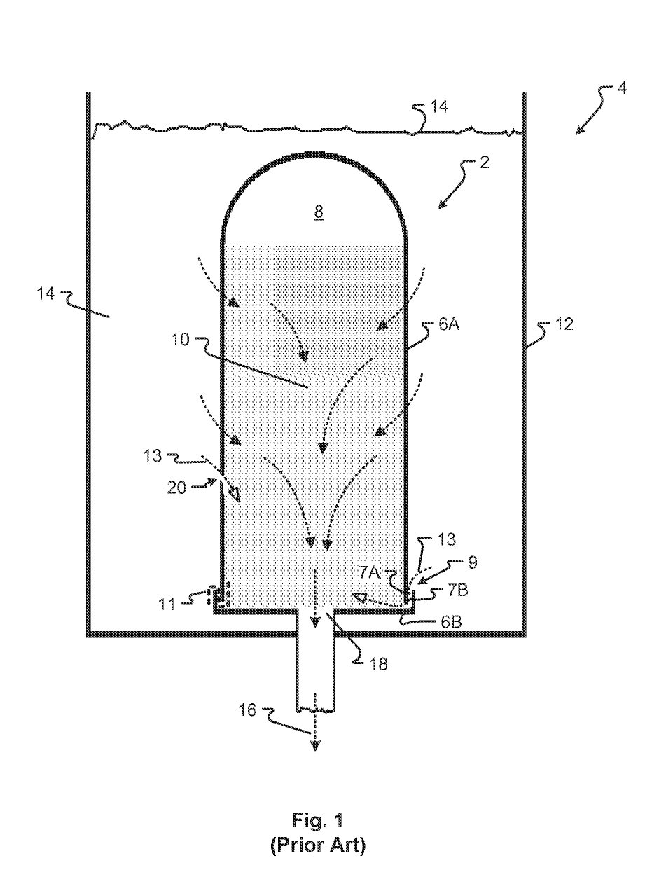

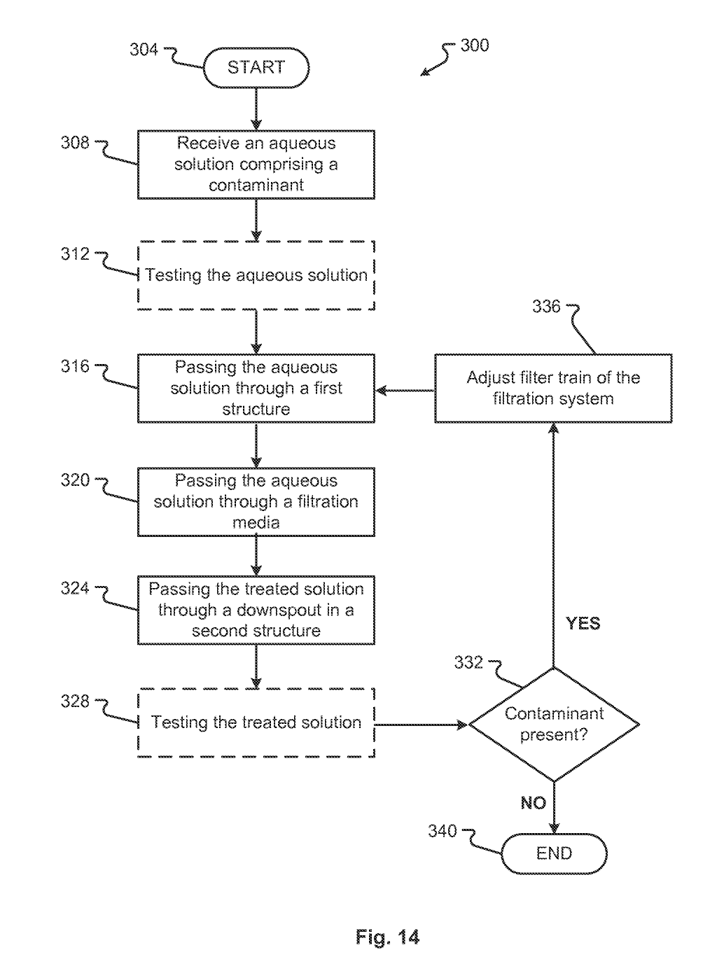

Referring now to FIG. 14, an embodiment of a method 300 for selectively targeting contaminants in an aqueous solution is generally illustrated. While a general order of the steps of the method 300 is shown in FIG. 14, the method 300 can include more or fewer steps or can arrange the order of the steps differently than those shown in FIG. 14. Generally, the method 300 starts with a start operation 304 and ends with an end operation 340. Hereinafter, the method 300 shall be explained with reference to the systems, filters, filtration media, components, etc. described in conjunction with FIGS. 1-13.

An aqueous solution is received that includes a contaminant in operation 308. The contaminant may be any undesirable or dangerous biological or chemical matter in the solution. The contaminates may include entrained solids (such a sediments), microbes, viruses, entrained un-dissolved contaminants, and dissolved chemicals (including chemicals that add undesirable tastes, smells, and colors to the solution.

Optionally, in block 312, the aqueous solution may be tested to determine the type and quantity of contaminants present. It will be appreciated that the solution may include more than one contaminant and different contaminants may be present in different quantities. Further, the type and concentration of contaminants may be used to select one or more of a filtration media used to treat the water, a type of filter used to treat the water, and a flow rate of water through the system. For example, if the aqueous solution does not include certain types of contaminants, a pre-filter 178 or a mechanical filter 170, 270, 270A may not be necessary or desirable for use with the system 104, 204. Optionally, if the water includes only a low concentration of a certain type of contaminate, the flow rate through the system may be increased. Increasing the flow rate may comprise increasing the number, type, or shape of apertures in a first structure, such as top portion 126, of the system 104, 204. The flow rate may also be adjusted by installing a different top portion. Optionally, increasing the flow rate may comprise using a bottom portion 134A with more than one outlet 136A. The type of contaminants in the solution may also optionally be used to adjust the order of filters, or the number of filters, used in the system 104, 204. For example, if certain contaminants are present, it may be beneficial to add a pre-filter upstream to the filtration media or downstream of the filtration media.

In block 316, the aqueous solution is passed through a perforated first structure, such as top portion 126, of a filter 122/222. The first structure includes perforations that can be used to adjust a rate of flow the aqueous solution through the system.

The aqueous solution then, in block 320, passes through a filtration media 160 in a chamber of the filter 122/222. The filtration media may comprise any type or form of filtration media described herein. Optionally, the filtration media may be placed in a container, such as a bag 162. Additionally, the filtration media may comprise two or more different types of filtration media. The different types of filtration media may be separated in layers or mixed together. Optionally, the different types of filtration media may be placed in one or more different bags 162. Optionally, method 300 may further comprise monitoring the quantity of aqueous solution that passes through filtration media. Accordingly, after a predetermined quantity of the aqueous solutions has passed through the filtration media, the filtration media may be replaced.

The treated solution passes through an outlet 136, 136A in a second structure, such as bottom portion 134, 134A, in block 324. The second structure is releasably and selectively interconnected to the first structure. Accordingly, a user may remove the first structure from the second structure to change, or adjust, the filtration media. A downspout 144 may optionally be interconnected to the outlet. The downspout may optionally include a screen 154 that retains a filter that may be adjusted to alter the flow rate of the aqueous solution through the filtration media. The filter may comprise a pre-filter 178 or other any other type of physical barrier, including a fabric (such as felt) or a ceramic material.

Optionally, at block 328, the treated solution may be tested for contaminants. In one embodiment, the testing is performed periodically after a predetermined period after a first quantity of solution has passed through the filtration media. In another embodiment, the testing is performed after a predetermined quantity of aqueous solution passes through the filtration media. In still another embodiment, the testing of block 328 is performed at least once after an initial amount of aqueous solution passes through the filtration media. The method 300 then proceeds to decision block 332. If contaminates are present in the treated water (or if certain types or quantities of contaminates are present above a predetermined level), method 300 proceeds YES to block 336. If contaminates are not present, or present in acceptable amounts, method 300 proceeds NO to end 340.

In block 336, the method may optionally include adjusting the filter train of the filtration system. Adjusting the filter train may comprise one or more of the group comprising: (1) adjusting the flow rate of the aqueous solution through the system; (2) adjusting the type or quantity of filtration media; (3) adding (or adjusting) a pre-filter 178, 270 upstream to the filtration media; (4) adding (or adjusting) a mechanical filter 170, 270A downstream to the filtration media; (5) adding a settlement vessel upstream of at least the filtration media; and (6) exposing the solution to an ultraviolet light, such as UV light source 290. The settlement vessel may comprise one or more containers where the aqueous solution remains for a predetermined period of time before the aqueous solution passes through the first structure. Optionally, a coagulant may be added to the solution in the settlement vessel. Adjusting the flow rate may comprise one or more of: decreasing the number of perforations in the first structure; adjusting a filter media positioned in a portion of the downspout; and altering the number or type of mechanical filter downstream to the filtration media. After adjusting the filter train in block 336, method 300 loops to block 316. It will be appreciated that method 300 may loop from block 328 to block 332 and 336 any number of times.

The description of the present disclosure has been presented for purposes of illustration and description, but is not intended to be exhaustive or limiting of the disclosure to the form disclosed. Many modifications and variations will be apparent to those of ordinary skill in the art. The embodiments described and shown in the figures were chosen and described in order to best explain the principles of the disclosure, the practical application, and to enable those of ordinary skill in the art to understand the disclosure.

While various embodiments of the present disclosure have been described in detail, it is apparent that modifications and alterations of those embodiments will occur to those skilled in the art. Moreover, references made herein to “the present disclosure” or aspects thereof should be understood to mean certain embodiments of the present disclosure and should not necessarily be construed as limiting all embodiments to a particular description. It is to be expressly understood that such modifications and alterations are within the scope and spirit of the present disclosure, as set forth in the following claims.

What is claimed is:

1. A water filtration system configurable by a user, comprising:
a chemical and/or biological filter including a vessel with an inlet and an outlet, the vessel including a chamber accessible by the user, the chamber configured to retain a predetermined quantity of chemical filtration media selected by the user; and
a mechanical filter with pores of a size selected by the user.

2. The water filtration system of claim 1, wherein the chemical filter and the mechanical filter comprise a filter train that is configurable by the user.

3. The water filtration system of claim 2, wherein the chemical filter is positioned in the filter train upstream of the mechanical filter.

4. The water filtration system of claim 2, wherein the mechanical filter is positioned in the filter train upstream of the chemical filter.

5. The water filtration system of claim 1, wherein the vessel of the chemical filter comprises:
a top portion including a plurality of apertures forming the vessel inlet;
a bottom portion releasably interconnected to the top portion to form the vessel chamber, the bottom portion including the vessel outlet; and
a downspout adapted to be interconnected to the vessel outlet of the bottom portion, the downspout adapted to receive a mechanical filter.

6. The water filtration system of claim 5, wherein the bottom portion of the chemical filter further comprises a flange projecting axially into the chamber, the flange positioned proximate to a radial edge of the outlet.

7. The water filtration system of claim 1, further comprising a siphon interconnected to an outlet of one of the chemical filter and the mechanical filter.

8. The water filtration system of claim 1, further comprising a second mechanical filter.

9. The water filtration system of claim 8, wherein the second mechanical filter is arranged in series with the mechanical filter, and wherein the second mechanical filter is positioned upstream of the chemical filter and the mechanical filter.

10. The water filtration system of claim 9, wherein the second mechanical filter comprises a fabric material.

11. The water filtration system of claim 9, wherein the second mechanical filter comprises one or more of a different pore size and a different filter material than the mechanical filter.

12. The water filtration system of claim 8, wherein the second mechanical filter is arranged in parallel with the mechanical filter.

13. The water filtration system of claim 12, wherein the second mechanical filter comprises a plurality of mechanical filters.

14. A filter for a water filtration system, comprising:
a vessel including:
a top portion with a plurality of apertures adapted to facilitate a flow of untreated water into the vessel;
a bottom portion selectively and removably interconnected to the top portion to form a chamber, the bottom portion including an outlet for treated water;
a chemical or biological filtration media removably positioned in the chamber to remove and/or neutralize a selected contaminant; and
a downspout interconnectable to the outlet, the downspout adapted to direct the treated water to a storage container.

15. The filter of claim 14, wherein the downspout is adapted to receive a mechanical filter.

16. The filter of claim 14, wherein the vessel chamber is accessible by the user, the chamber configured to retain a predetermined quantity of chemical filtration media selected by the user.

17. The filter of claim 14, further comprising:
a first structure associated with the top portion; and
a second structure associated with the bottom portion, the second structure adapted to be received at least partially within the first structure to interconnect the bottom portion to the top portion.

18. The filter of claim 17, wherein the first structure comprises a cavity and the second structure comprises a projection adapted to at least partially fit within the cavity.

19. The filter of claim 17, wherein the first structure comprises a helical track along an interior surface of the top portion and the second structure comprises at least one tab on an exterior surface of the bottom portion, wherein the at least one tab may be received within the helical track to threadably interconnect the bottom portion to the top portion.

20. The filter of claim 17, wherein the second structure further comprises an aperture adapted to receive a fixture, wherein the fixture is retained at least partially by the first structure to interconnect the bottom portion to the top portion.

21. A method, comprising:
receiving an aqueous solution comprising a contaminant;
passing the aqueous solution through a perforated first structure, the perforated first structure controlling a rate of flow the aqueous solution;
thereafter passing the aqueous solution through a filtration media in a chamber to remove or otherwise neutralize the contaminant and form a treated solution; and
passing the treated solution through a downspout in a second structure, wherein the first and second structures removably engage one another to enable a user to place selectively different filtration media in the chamber to target one or more other selected contaminants in a different received aqueous solution.
